(19) United States
(12) Patent Application Publication
(10) Pub. No.: US 2007/0066116 A1
(43) Pub. Date: Mar. 22, 2007

(54) CABLE FEED-THROUGH

(75) Inventor: Klaus Manfred Steinich, Zorneding (DE)

Correspondence Address: HEAD, JOHNSON & KACHIGIAN, 228 W 17TH PLACE, TULSA, OK, 74119, US

(73) Assignee: ASM AUTOMATION SENSORIK MESSTECHNIK GMBH, Moosinning (DE)

(21) Appl. No.: 11/550,627

(22) Filed: Oct. 18, 2006

Related U.S. Application Data
(63) Continuation-in-part of application No. 11/388,105.
(63) Continuation-in-part of application No. 10/963,177, filed on Oct. 12, 2004, now abandoned.

(30) Foreign Application Priority Data
Oct. 20, 2003 (DE) 20316059.2

(51) Int. Cl. H01R 13/62

(52) U.S. Cl. 439/320

(57) ABSTRACT

A tension-relief cable feed-through for an electrical cable having an external diameter with insulation therearound and having a feed-through sleeve having a passageway therethrough which has an internal thread with an internal diameter having thread turns with indentations therebetween such that when the electrical cable is screwed into the passageway, the thread turns of the internal thread press in a form-closing manner into the outer circumference of the insulation surrounding the electrical cable.

### CROSS-REFERENCE TO RELATED APPLICATIONS

This is a U.S. continuation-in-part patent application which claims priority to U.S. patent application Ser. No. 11/388,105 filed Mar. 23, 2006 which claims priority to U.S. patent application Ser. No. 10/963,177 filed Oct. 12, 2004, now abandoned, which claims priority to German Application No. 20316059.2 filed October 2003.

### BACKGROUND OF THE INVENTION

1. Field of Invention

The present invention relates to a tension-relief feed-through of an electric cable through a solid component, for instance a housing component, and in particular a housing cover.

2. Prior Art

Since the electric contact of the wires or cores of a cable with the component to be connected, for example an electronic board, cannot usually bear large amounts of mechanical forces, a so-called tension-relief is very often required for electric connecting cables. This serves to prevent a snapping or disconnecting of the electric connection between the cable and the remainder of the electric device if the cable is pulled too much.

To this end, the cable is in most cases connected to the housing component in a mechanically fixed manner at the passage portion through the housing component, for example by being clamped by means of a tightening clamping rail on a foundation such as the housing component. Tension-relief devices of such kind require an additional constructional space and, in the case described here, a tightening of at least two screws during the assembly.

Another commonly used tension-relief is to feed a cable through the passage of a feed-through sleeve which possesses an external thread at its outer circumference. A coupling nut, which has been threaded onto the cable prior to the feed-through of the cable and has an internal thread that fits onto the external thread and likewise possesses a passage for the cable, can be screwed onto the feed-through sleeve after the cable has been fed through. As a result, the free internal cross section of the feed-through sleeve is being pressed together which is due to a conical design either of this internal cross section and/or of the thread.

However, on account of the conicity, the production of such a feed-through sleeve proves to be complicated and an additional component in the form of a coupling nut is required and during the assembly the preceding threading of the coupling nut onto the cable must not be forgotten, as this may otherwise lead to an additional amount of work.

Several prior art connectors have been proposed in the past. Kuwayama et al. (U.S. Publication No. 2002/0096352) discloses a cable with multiple conductors 3 wherein the multiple conductors are uninsulated from each other. Additionally, the connector itself, while including a reduced diameter section, does not include internal threads for joining with the cable.

Ballog (U.S. Pat. No. 5,474,478) discloses a connector for a single wire coaxial cable with a surrounding threaded wire mesh. Ballog does not disclose multiple cores insulated from each other.

There remains a need for a tension relief connector for a plurality of individual wires or cores forming a cable having external insulation wherein the connector includes a passageway with thread turns that press in a form closing manner in the external insulation.

There also remains a need for a tension relief connector for a plurality of individual wires or cores forming a cable wherein the individual wires or cores may be connected to various connections to form separate circuits.

### SUMMARY OF THE INVENTION

Therefore an object in accordance with the invention is to develop a tension-relief which can be produced and assembled in a simple and cost-effective manner.

Provided that the external diameter of the cable is larger in the tension-relieved condition than the free passage of the internal thread of the passage, the thread turns of the internal thread press into the outer circumference of the insulation, and hence the outer circumference of the cable, as soon as the cable is located in the axial length portion of the thread.

In this manner, an axially tight connection is established between the cable and the feed-through sleeve and thus a tension-relief.

To achieve this it must be ensured on the one hand that the insulation of the cable has a sufficient thickness so that the thread turns that press into the outer circumference cannot reach or damage the cores in the inside of the insulation.

On the other hand, the external diameter of the cable should not be of such a image dimension that its insertion into the axial portion of the internal thread requires too great an expenditure of force, for instance if in the tension-relieved condition the external diameter of the cable is considerably larger than the nominal diameter of the thread, hence the diameter measured between the indentations of the thread turns.

The cable can be inserted into the axial length portion of the internal thread by advancing the cable axially, which, however, requires a relatively great expenditure of force.

A less quick but more reliable method of insertion is to screw the feed-through sleeve with the internal thread of the passage onto the external diameter of the cable, i.e. its insulation.

Especially if the thread turns are designed in a sufficiently pointed manner so that they cut into the plastic material of the cable insulation, a connection is provided between the parts that is of particular axial tightness.

Apart from the kind of insulation, which usually is a plastic material, and its absolute tensile strength, the tensile-loaded capacity of this connection depends on the prestressing of the insulation in the radial direction. By preference, the external diameter of the cable is therefore slighty larger in the initial condition than the nominal diameter of the internal thread.

In order that the first turn of the internal thread in the screwing direction still seizes the insulation of the cable without too great an expenditure of force, there are several possibilities as stated below:

The passage including the internal thread, hence also the nominal diameter of the internal thread, may be tapered in the screwing direction of the cable. In this case, the external diameter of the cable is smaller in the initial condition than the nominal diameter of the thread at the wide end but larger than the nominal diameter at the narrow end.

Another solution is to leave the nominal diameter of the thread unchanged but to design the first thread turns in the screwing direction with a smaller pitch of the thread turns and to reach the complete thread pitch in the course of the first thread turns.

Both possibilities are costly, since they can hardly be reconciled with the standardized, cost-effective production methods for threads.

A third possibility resides in the fact that the internal thread and also the passage in the portion of the internal thread are not of a conical design but that in the inserting direction of the cable a feeding pipe in the form of an extension of the passage is prearranged before the internal thread coaxially thereto and that the internal diameter of this feeding pipe is designed conically with a narrowing towards the internal thread.

Preferably, the free diameter of the feeding pipe then corresponds approximately to the nominal diameter of the internal thread at the end facing towards the internal thread.

Inasmuch as the electric cable concerned here is a cable with a shielding, i.e. with a mesh of metal filaments contained in the insulation coaxially between the outer circumference of the cable and the cores in the inside of the cable, the insulation is removed at an axial end portion of the cable prior to the insertion into the passage of the feed-through sleeve so that the cores of the cable project axially by this length from the removed insulation. In doing so, the shielding is not removed together with the insulation but kept long, i.e. it is cut according to the length of the cores, and before the insertion, i.e. the screwing-in or advancing of the insulation of the cable into the internal thread of the passage, it is bent backwards onto the external diameter of the insulation.

If the cable is then inserted into the passage only to such an extent that the insulation of the cable projects scarcely or to a minimum from the axial portion of the internal thread and if the shielding has been bent at least with a projecting length from the insulation in accordance with the axial length of the internal thread, the filaments or the mesh of the shielding is located between the outer circumference of the insulation of the cable and the internal thread of the passage and consequently in an electrically conductive contact with the internal thread.

If the feed-through sleeve consists of an electrically conductive material, such as metal, the shielding is thereby brought into electric contact with the feed-through sleeve and thus with the housing of the electric device to be connected.

As a result, a reliable sealed EMI-shielding of the cable is ensured on the one hand and on the other hand the tension-relief is influenced in a positive way, as the metal filaments of the shielding that extend in the axial direction along the internal thread additionally increase the tensile-loaded capacity of the connections.

In addition, the tensile-loaded capacity of the cable can be improved, especially when the latter is provided with a shielding, if the shielding projects at the face of the insulation and is not cut and if at least the shielding, preferably also the insulation of the cable, is bonded to the housing into which the cable is inserted. Owing to the numerous single wires or fibers of the shielding, which are mostly arranged in a mesh-like or web-like fashion, a highly form-locking connection with a resultant high load capacity is established between the cured sealing compound and the shielding and consequently an additionally improved tensile capacity is achieved.

### BRIEF DESCRIPTION OF THE DRAWINGS

In the following, a detailed description of an embodiment according to the invention will be given by way of example with reference to the Figures.

FIG. 1 shows a cross section through a first tension-relief according to the invention, in which only the right-hand part of the illustration shows the cable already located in the feed-through sleeve;

FIG. 2 shows a second embodiment; and

FIG. 3 shows a third embodiment.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

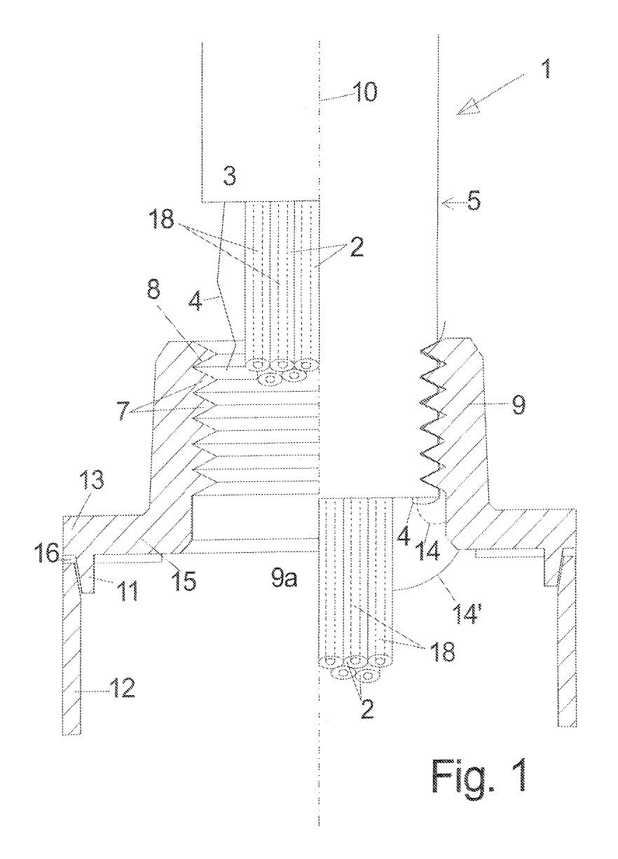

FIG. 1 is a longitudinal cross section showing the cable passage prior to the completion in the left half of the illustration and in the right half of the illustration in the completed state, i.e. after the cable 1 is located with its insulation 3 in the axial length portion of the internal thread 8.

The feed-through sleeve 9 has an internal thread 8, which usually has a rotationally symmetrical circular cross section, and here the feed-through sleeve 9 can be formed as an integral part of a cover 15 that is placed e.g. onto a profile or a housing 12.

The feed-through sleeve 9 extends from the principal plane of the cover 15 into one direction, while for instance guide extensions 11 extend into the other direction which facilitate a precise fitting of the cover 15 onto the adjoining component so as to permit afterwards the screwing through the cover against the profile or housing 12, preferably by interposing e.g. a flat sealing 16.

In the inside of the profile or housing 12, a plurality of individual wires or cores 2, each wire or core insulated from the others by insulation 18, project sufficiently in the longitudinal direction 10 from the insulation 3 of the cable 1 that was removed in the end portion of the latter, are to be connected with an electric component in the inside e.g. of the profile or housing 12. Stated in other words, each of the individually insulated wires or cores may individually be connected to separate connecting points within the housing 12, thereby forming separate electrical circuits for each of the individual wires or cores. These connection points, may in one embodiment, be located on different electronic components within the housing 12.

As shown in FIG. 1, the external diameter 5 of the cable 1 is approximately of the same length in the initial condition as the nominal diameter N of the internal thread 8. The cable 1 can therefore be screwed in from the outside with its insulation 3 into the internal thread 8 of the feed-through sleeve 9. The insulation 3 is thicker than the diameter of the teeth so that the sleeve is secured to the cable. After the first thread turns have sunk into the external diameter of the insulation 3, a form closure between both parts has already been established to an increasing extent during the gradual screwing-in, which form closure permits a retraction or advancing at a great expenditure of force only so that the most force-saving inserting direction proves to be the screwing-in which is preferably carried out until the front end of the insulation has just passed completely through the internal thread 8.

If the cable 1 has an electromagnetic shielding 4 in the form of a metal ware mesh in the proximity of the outer circumference and within the insulation 3 and thus concentrically around a plurality of individual wires or cores 2, with each of the individual wires or cores 2 insulated from the other by core insulation 18.

This shielding of the cable is to be maintained, the shielding 4 is cut to length together with the cores 2, as a result of which it projects from the insulation 3 that was cut to a shorter length.

Before the insertion of the cable 1 into the internal thread 8, this shielding 4 is bent backwards and thereby placed onto the external diameter of the cable 1—as depicted in the right half of the illustration—and during the screwing-in or insertion it is located between the internal thread 8 and the insulation 3. If the internal thread 8, by preference the entire cover 15, consists of an electrically conductive material, in particular metal, the cable 1 is thus connected in an EMI-sealed manner to the cover 15 and consequently to the housing of the electric device.

Apart from the feed-through sleeve 9 itself, there is no further component required for the described tension-relief cable feed-through, not even an additional fixing screw for the cable mounting, and the assembly is effected as quickly as the tightening of only one fixing screw.

Furthermore, in the right half of the illustration FIG. 1 shows a track or bead of cured adhesive or cured sealing compound 14 that is preferably provided over the entire circumference in the corner portion between the free face of the insulation 3 of the cable and the internal circumference of the feed-through sleeve 9. For this purpose, the cable 1 is advanced or screwed through the internal thread 8 only to such an extent that the internal diameter of the feed-through sleeve 9 is still located close to the external diameter 5 of the cable 1. The adhesive/sealing compound 14″ can also extend across the entire face of the cable 1 as far as the feed-through sleeve 9.

This bonding serves to improve the tensile-loaded capacity of the cable 1 which is therefore not only brought about by the form-closing engagement of the thread turns of the internal thread 8 into the insulation 3 of the cable but also by the bonding between the feed-through sleeve 9 and the insulation 3 and also between the shielding 4, provided that it also extends through this compound 14 and is bonded thereto.

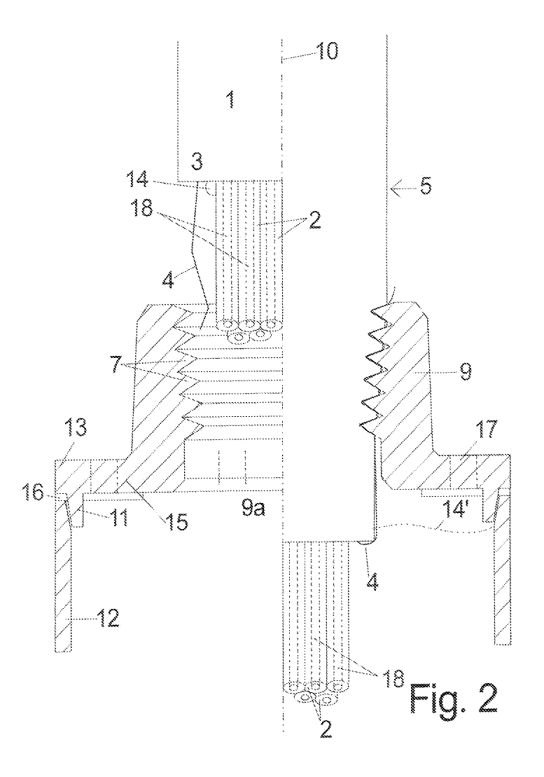

FIG. 2 differs from FIG. 1 in that the passage 9a including the internal thread 8 is designed conically, i.e. it has a tapered cross section in the screwing direction of the cable 1, whereby the screwing-in of the cable 1 is facilitated due to the fact that the first thread turns can be screwed easily and reliably onto the external diameter at the beginning of the cable.

This is facilitated in particular due to the fact that the external diameter 5 of the cable 1 is larger than the free passage at the second, free end of the passage, yet larger than the free passage at the inner, narrow end of the passage, in particular also larger than the internal diameter N.

Furthermore, FIG. 2 also differs from FIG. 1 in that a sealing compound 14″ is not just applied as a single track but that it substantially covers the housing 12 completely onto which the cover 15 with the feed-through sleeve 9 is placed. In order to be able to effect this after the placing of the cover 15, at least two openings 17 are provided in the cover 15, preferably on opposite sides with respect to the feed-through sleeve 9, of which one opening serves to fill in the sealing compound 14″ after the placing of the cover 15, while the other opening serves to exhaust the air displaced thereby inside the housing.

To further improve the tensile-loaded capacity of the cable 1, the cable 1 is in this case screwed to such an extent into the feed-through sleeve 9 and therethrough that the cable 1 projects with its insulation 3, and consequently also with the shielding 4 that may emerge at the face of the insulation and is bent backwards, into the bonding portion and is bonded, too. Especially the bonding of the shielding 4, which is in most cases designed in a mesh-like or netting-like manner, leads to a strong, form-closing and also force-locking connection of the cable 1 with the sealing compound 14″, whereby the cable is connected in a fixed manner to the housing or profile.

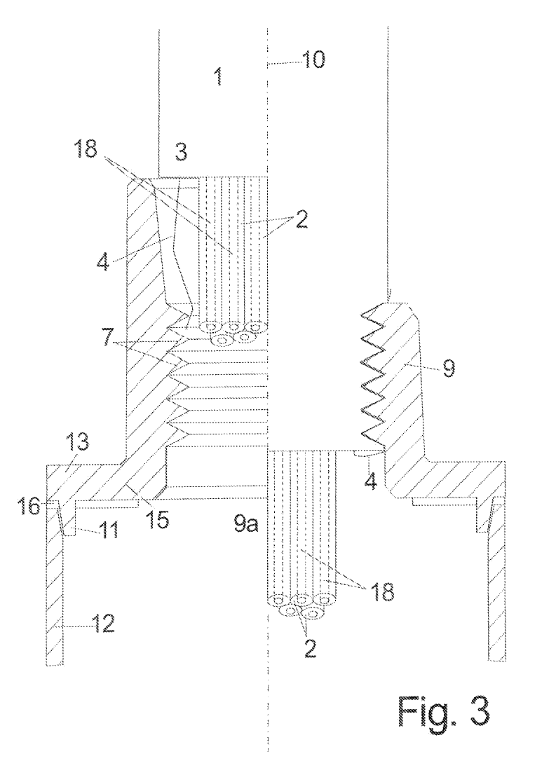

In FIG. 3, the internal thread 8 is designed with a constant diameter over the entire length, just as in FIG. 1, but in the inserting direction of the cable 1 a feeding pipe 6 is arranged before the internal thread 8 which is in particular designed integrally with the feed-through sleeve 9.

The internal diameter of the feeding pipe 6 is tapered towards the internal thread 8, while the external diameter 5 of the cable is smaller than the internal diameter of the the feeding pipe 6 at its free, open end, but larger than at least the free passage of the internal thread 8, preferably also larger than the internal diameter N of the internal thread 8.

While the invention has been described with a certain degree of particulary, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

What is claimed is:

1. A tension relief cable feed-through comprising:
a cable having an external diameter with external insulation therearound and having a plurality of individual wires or cores, each said wire or core insulated from the others by core insulation; and
a feed-through sleeve having a passageway therethrough, said passageway having an internal diameter with thread turns, such that when the cable is screwed into the sleeve, the cable protrudes axially at an inner side of the sleeve and projects into an adjoining housing and the thread turns press in a form closing manner into the outer circumference of the external insulation of the cable.

2. A tension relief cable feed-through as set forth in claim 1 including a metal shielding between said plurality of cores and said external insulation.

3. A tension relief cable feed-through as set forth in claim 1 wherein said external insulation is thicker than the teeth diameter of the thread turns.

4. A tension relief cable feed-through as set forth in claim 1 wherein said feed-through sleeve is manufactured as a stamped metal part.

5. A tension relief cable feed-through as set forth in claim 1 wherein said thread turns are manufactured as a threaded nozzle.

6. A tension relief cable feed-through as set forth in claim 1 including an adhesive or sealing compound between said external insulation and said passageway.

7. A tension relief cable feed-through as set forth in claim 1 wherein said passageway is conical.

8. A tension-relief cable feed-through according to claim 1 wherein in a relieved condition said external diameter of said electrical cable is not larger than a nominal diameter of said internal thread by more than 20%.

9. A tension-relief cable feed-through according to claim 1 wherein said thread turns consist of an electrically conductive material.

10. A tension-relief cable feed-through according to claim 1 wherein the entire said feed-through sleeve consists of an electrically conductive material.
